(19) United States
(12) Patent Application Publication
(10) Pub. No.: US 2008/0153557 A1
(43) Pub. Date: Jun. 26, 2008

(54) System of Radiocommunication

(76) Inventor: Vladimir Anatolevich Matveev, Tver (RU)

Correspondence Address: I. Zborovsky, 6 Schoolhouse Way, Dix Hills, NY, 11746, US

(21) Appl. No.: 11/886,392

(22) PCT Filed: Aug. 29, 2006
(86) PCT No.: PCT/RU2006/000451

§ 371 Date: Sep. 14, 2007

(30) Foreign Application Priority Data
Apr. 4, 2006 (RU) 2006110834

(51) Int. Cl. H04M 1/02

(52) U.S. Cl. 455/575.2

(57) ABSTRACT

A system of radio communication for a sports command game has players receiving/transmitting devices located in helmets of players, a coach receiving-transmitting device provided for a coach, and a digital radio line of communication connecting the players receiving/transmitting devices and the coach receiving/transmitting device with each other.

The present invention relates to systems of radio communication, in particular for sports equipment of players in hockey with a puck and ball, in soccer, ragby and American football. In the present case there is no special communication between players and a coach, as well as between the players during playing of games or training. The communication takes place only by means of voice and gestures. This creates significant inconvenience both for the players, the coach, and also viewers who observe the game.

The objective of the utility model is to develop a system of communication between players and a coach, as well as between the players during training and playing a game.

The technical result is a provision of a possibility of radio communication between a coach and players during playing the game and training.

This technical result is achieved in that the system of communication for sports command game includes a transmitting-receiving devices, which are located in helmets of players and connected between each other and the transmitting-receiving device of a coach by a digital radio line of communication. The transmitting-receiving device includes a radio transmitter with a transmitting antenna and a microphone and the radio receiver with a receiving antenna and a telephone. The radio transmitter and the radio receiver are located on the sides of the helmet at the opposite sides, and their antennas are mounted in its top part. The transmitting-receiving device is formed removable and mounted inside the helmet between a housing and a damping partition. The radio line of communication is configured in a centimeter range of electromagnetic waves. The transmitting/receiving device of a coach is configured as a radio telephone with a speaker.

The invention is illustrated by drawings, where on

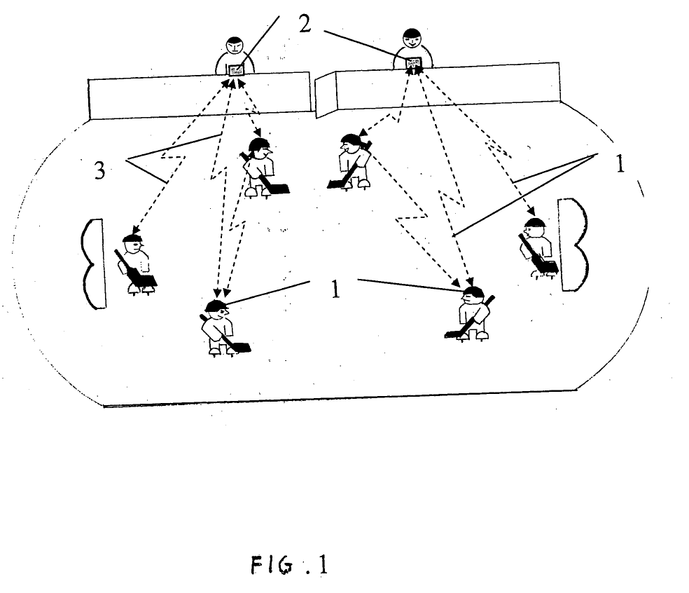

FIG. 1 a functional diagram of a system of radio communication for a sports command game is shown, and; on

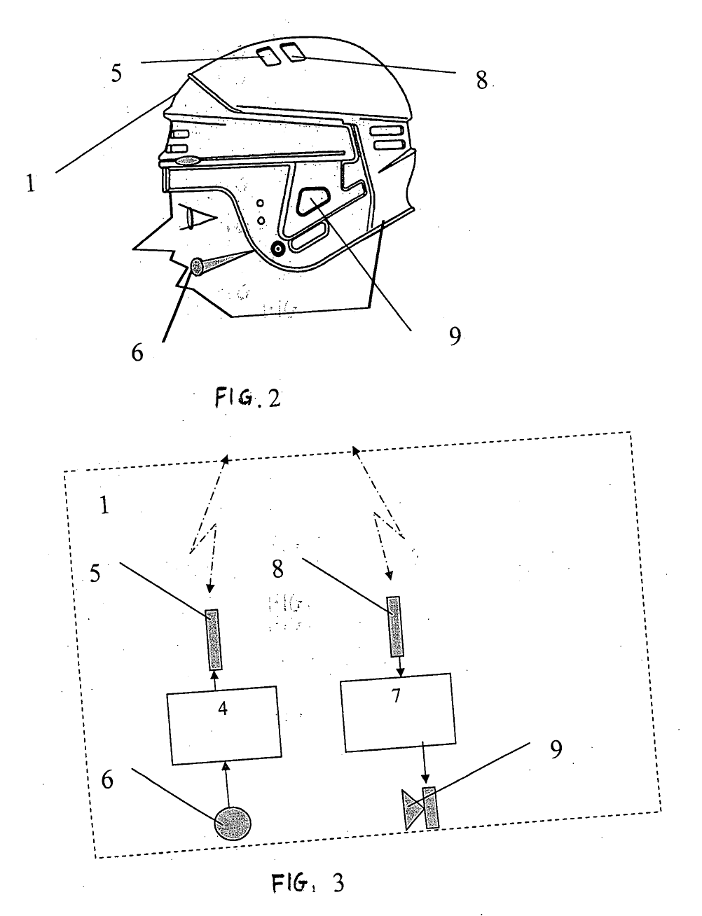

FIG. 2 a hockey helmet is shown, provided with a receiving/transmitting device.

The system of radio communication for a sports command game includes receiving/transmitting devices of players, arranged in helmets 1 and connected with one another and with a receiving/transmitting device of a coach by a digital/radio line of communication 3. The receiving/transmitting device of the players and the coach contain a radio transmitter 4 with a transmitting antenna 5 and a microphone, and a radio receiver 7 with a receiving antenna 8 and a telephone 9. The radio transmitter 4 and the radio receiver 7 of the players are located on the sides of the helmet 1 from opposite sides, and their antennas 5 and 8 are mounted in a top between its housing and a damping partition. This configuration of the receiving/transmitting device provides comfort of its use by all players, and also allows to adjust them to a required frequency, to repair and to exchange. The radio line 3 of communication is configured in a centimeter range of electromagnetic valves. The receiving-transmitting device 2 of the coach is configured as a radio telephone of a speaker.

The system of the radio communication for the sports command game operates in the following manner. Before the beginning of a game or training, in response to a command by a coach, the receiving-transmitting devices of the coach and of players are turned on. After this a radio communication is established between them via the radio line 3 on a common frequency, providing a possibility of reception and transmission of radio coded sound signals between the players and the coach. By means of the radio telephone 2 the voice commands of the coach are converted into pulse-code radio signals, which are transmitted via the lines of communication 3 to the receiving antennas 8 in the helmets 1 of the players. The radio signals received by the antenna 8 is supplied to the receiver 7, where they are converted into analog electrical signals of a sound frequency and transmitted to the telephone 9. In the telephone 9 the electrical signals are converted into acoustic sound waves, which are received by years of a player. The player informs a coach about his receipt of the command by transmission of a corresponding speech message into the microphone 6. In the microphone 6 acoustic waves of the speech message are converted into an electric signal of sound frequency and then from the microphone 6 supplied to an input of the transmitter 4. The transmitter 4 converts the received electrical signal into a pulse-code radio signal, which through the antenna 8 and the radio line 3 is supplied to the input of the radio telephone 2. The radio telephone 2 converts the received pulse-code signal into an acoustic signal which is received by years of the coach. In an analogous manner the radio communication between the individual players in a team is performed as well.

In the present time the system of the radio communication for the sports command game is developed on a level of technical proposal.

1-6. (canceled)

7. A system of radio communication for a sports command game, comprising players receiving/transmitting devices located in helmets of players; a coach receiving-transmitting device provided for a coach; and a digital radio line of communication connecting said players receiving/transmitting devices and said coach receiving/transmitting device with each other.

8. A system of radio communication according to claim 7, wherein each of said players receiving/transmitting devices contains a radio transmitter with a transmitting antenna and the microphone, and also a radio receiver with a receiving antenna and telephone.

9. A system of radio communication according to claim 7, wherein said radio transmitter and said radio receiver are located on sides of a helmet from its opposite sides, and their antennas are mounted in a top part of the helmet.

10. A system of radio communication according to claim 7, wherein each of said players receiving-transmitting devices is configured as a removable device and fixed inside the helmet between a housing and a damping partition.

11. A system of radio communication according to claim 7, characterized in that said radio line of communication is configured in a centimeter range of electromagnetic waves.

12. A system as defined in claim 1, wherein said coach receiving-transmitting device is configured as a radio telephone with a speaker.
